(19) United States
(12) Patent Application Publication
(10) Pub. No.: US 2026/0369683 A1
(43) Pub. Date: Nov. 19, 2026

(54) ELECTRODE ASSEMBLY AND SECONDARY BATTERY INCLUDING THE SAME

(71) Applicant: Samsung SDI Co, Ltd., Yongin-si (KR)

(72) Inventors: Eunjeong Moon, Yongin-si (KR); Donghyun Kim, Yongin-si (KR); Yejin Seo, Yongin-si (KR); Taesu Jeong, Yongin-si (KR)

(73) Assignee: Samsung SDI Co, Ltd., Yongin-si (KR)

(21) Appl. No.: 19/664,132

(22) Filed: Apr. 30, 2026

(30) Foreign Application Priority Data
May 19, 2025 (KR) 10-2025-0064678

(51) Int. Cl. H01M 10/0583; H01M 4/02; H01M 4/66; H01M 50/46; H01M 50/538

(52) U.S. Cl. CPC H01M 10/0583; H01M 4/667; H01M 4/668; H01M 50/46; H01M 50/538; H01M 2004/021

(57) ABSTRACT

An electrode assembly includes a first electrode plate, a second electrode plate, and a separator interposed between the first electrode plate and the second electrode plate. The first electrode plate includes a first polymer substrate, a first metal layer on one surface of the first polymer substrate, and a plurality of first active material layers on the first metal layer. The second electrode plate includes a second polymer substrate, a second metal layer on one surface of the second polymer substrate, and a plurality of second active material layers on the second metal layer. The first electrode plate, the separator, and the second electrode plate are folded in a zigzag shape and stacked together.

### CROSS-REFERENCE TO RELATED APPLICATION

This present application claims priority to and the benefit under 35 U.S.C. §119(a)-(d) of Korean Patent Application No. 10-2025-0064678, filed on May 19, 2025, in the Korean Intellectual Property Office, the entire disclosure of which is incorporated herein by reference.

### BACKGROUND

### Field

The present disclosure relates to an electrode assembly and a secondary battery using the same.

### Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A plurality of positive electrodes and a plurality of negative electrodes may be alternately stacked one by one with a separator therebetween to configure an electrode assembly. In this case, because the positive electrode and the negative electrode are separated by the separator, a separate conductive substrate capable of joining currents on two conductive layers must be welded.

The herein information disclosed in this Background section is for enhancement of understanding of the background of the present disclosure, and therefore, it may contain information that does not constitute related (or prior) art.

### SUMMARY

A problem to be solved by the present disclosure is to provide an electrode assembly for solving the herein described technical problems and a secondary battery using the same.

In some embodiments, an electrode assembly includes a first electrode plate including a first polymer substrate, a first metal layer on one surface of the first polymer substrate, and a plurality of first active material layers on the first metal layer, a second electrode plate including a second polymer substrate, a second metal layer on one surface of the second polymer substrate, and a plurality of second active material layers on the second metal layer, and a separator interposed between the first electrode plate and the second electrode plate. The first electrode plate, the separator, and the second electrode plate are folded in a zigzag shape and stacked together.

In some embodiments, a secondary battery includes an electrode assembly including a first electrode plate including a first polymer substrate, a first metal layer on one surface of the first polymer substrate, and a plurality of first active material layers on the first metal layer, a second electrode plate including a second polymer substrate, a second metal layer on one surface of the second polymer substrate, and a plurality of second active material layers on the second metal layer, and a separator interposed between the first electrode plate and the second electrode plate, a first electrode tab on the first metal layer, a second electrode tab on the second metal layer, and a case configured to accommodate the electrode assembly. The first electrode plate, the separator, and the second electrode plate are folded in a zigzag shape and stacked together.

According to some embodiments of the present disclosure, metal layers formed on an electrode plate are continuously connected, so that one conductive layer may be formed. Accordingly, there is no need to form an electrode tab by attaching a separate conductive substrate as in the related art, and a manufacturing process of the electrode assembly may be simplified and a process cost may be reduced. In addition, the number of times of welding the electrode tab and the number of used welding protection tapes are minimized, so that efficiency and productivity of the secondary battery may be improved.

According to some embodiments of the present disclosure, in the related art, a conductive layer forms an outermost part in an electrode assembly using a composite substrate, whereas in the present disclosure, an insulator may surround an outermost part of the electrode assembly. Accordingly, by preventing the electrode assembly from being exposed from an external environment, electrical reliability and stability of the secondary battery using the electrode assembly may be improved.

However, aspects and features of the present disclosure are not limited to those described herein, and other aspects and features not mentioned will be clearly understood by a person skilled in the art from the detailed description, described herein.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a secondary battery including an electrode assembly according to some embodiments of the present disclosure.

FIG. 2 is a diagram illustrating an electrode assembly according to some embodiments of the present disclosure.

FIG. 3 illustrates first and second electrode plates in a state before bending according to some embodiments of the present disclosure.

FIG. 4 illustrates a welding structure of an electrode tab according to some embodiments of the present disclosure.

FIG. 5 illustrates a structure in which a separator finishes an outermost part of an electrode assembly according to some embodiments of the present disclosure.

FIGS. 6 to 7 illustrate a welding structure of an electrode tab according to some embodiments of the present disclosure.

FIG. 8 illustrates a structure in which a separator finishes an outermost part of an electrode assembly according to some embodiments of the present disclosure.

FIG. 9 is a diagram illustrating a structure of an electrode assembly according to some embodiments of the present disclosure.

FIG. 10 illustrates first and second electrode plates in a state before bending according to some embodiments of the present disclosure.

FIG. 11 illustrates a structure in which a separator finishes an outermost part of an electrode assembly according to some embodiments of the present disclosure.

FIG. 12 is a diagram illustrating a structure of an electrode assembly according to some embodiments of the present disclosure.

FIG. 13 illustrates a structure in which a separator finishes an outermost part of an electrode assembly according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her disclosure in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

As described herein, in configuring an electrode assembly, a plurality of positive electrodes and a plurality of negative electrodes may be alternately stacked one by one with a separator therebetween to configure an electrode assembly. In this case, because the positive electrode and the negative electrode are separated by the separator, a separate conductive substrate capable of joining currents on two conductive layers must be welded. The inventors have recognized that this presents a problem that separate materials and processes are required.

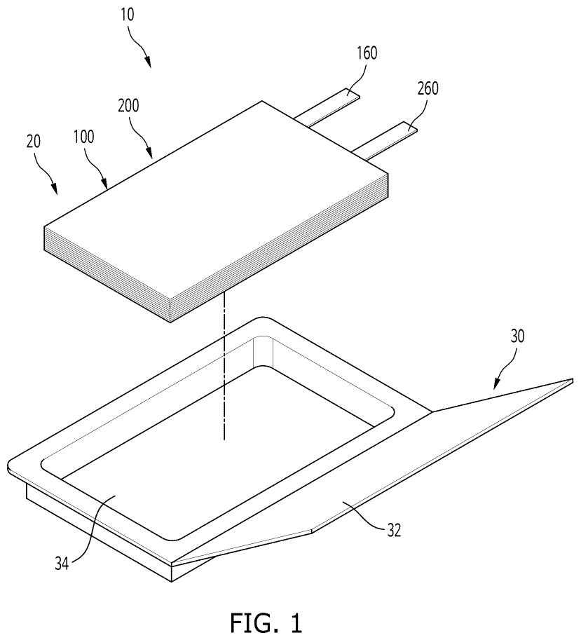

FIG. 1 illustrates a secondary battery including an electrode assembly according to some embodiments of the present disclosure. As illustrated, a secondary battery 10 may include a case 30 and an electrode assembly 20 disposed inside the case 30.

The electrode assembly 20 is accommodated inside a lower case 34, and the electrode assembly 20 may include a first electrode plate 100, a second electrode plate 200, a first electrode tab 160, and a second electrode tab 260. The electrode assembly 20 may have a configuration in which the first electrode plate 100 and the second electrode plate 200 are folded multiple times in a bent zigzag pattern with a separator therebetween.

The case 30 may include an upper case 32 and the lower case 34. In an example, the upper case 32 and the lower case 34 may be integrally connected.

The case 30 forms an overall appearance of the secondary battery 10 and may be formed of a conductive metal such as aluminum, an aluminum alloy, nickel-plated steel, steel, etc.

In FIG. 1, the case 30 is a pouch-type case, and the secondary battery 10 is illustrated as a pouch-type secondary battery, but the scope of the present disclosure is not limited thereto. The secondary battery 10 may be a secondary battery of any shape such as a prismatic type, a cylindrical type, etc.

The secondary battery 10 may be a lithium secondary battery, a sodium secondary battery, etc. However, the scope of the present disclosure is not limited thereto, and the secondary battery 10 includes all batteries capable of repeatedly providing electricity by charging and discharging.

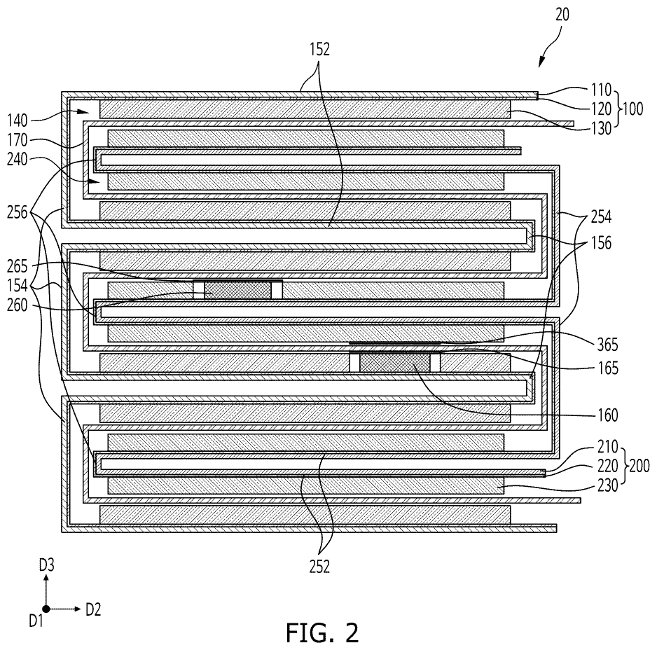

FIG. 2 is a diagram illustrating an electrode assembly according to some embodiments of the present disclosure.

In embodiments, the electrode assembly 20 may include the first electrode plate 100, the first electrode tab 160, a first insulating layer 165, a separator 170, the second electrode plate 200, the second electrode tab 260, a second insulating layer 265, and a third insulating layer 365.

The first electrode plate 100 may include a first polymer substrate 110, a first metal layer 120 disposed on one surface of the first polymer substrate 110, and a plurality of first active material layers 130 disposed on the first metal layer 120. The first electrode plate 100 may serve as a negative electrode, and the second electrode plate 200 further described herein may serve as a positive electrode. Of course, the reverse is also possible. Hereinafter, a case where the first electrode plate 100 is a negative electrode plate will be described as a reference.

For example, the first polymer substrate 110 may be formed of an insulating material or a polymer such as PET, PP, PE, PS, PI, and PU. However, the present disclosure is not limited thereto.

The first metal layer 120 may serve as a current collector of the negative electrode. In this case, the first metal layer 120 may include copper (Cu). However, the present disclosure is not limited thereto. A metal layer may not be disposed on the other surface of the first polymer substrate 110, in some embodiments.

The plurality of first active material layers 130 may be disposed to be spaced apart along a surface of the first metal layer 120. The plurality of first active material layers 130 may be disposed on a first flat portion 152 of the first electrode plate 100.

The plurality of first active material layers 130 may be electrically connected to each other through the first metal layer 120. Accordingly, there is no need to attach a separate substrate tab or the like for electrically connecting the plurality of first active material layers 130, so that a manufacturing process may be simplified and a manufacturing cost may be reduced.

According to the herein-described configuration, because the first metal layer 120 and the first active material layer 130 are disposed on one surface of the first polymer substrate 110, and a metal layer is not disposed on the other surface of the first polymer substrate 110 on which the first metal layer 120 is not disposed, an amount of metal used in the first electrode plate 100 may be reduced. Accordingly, a weight and a manufacturing cost of the electrode assembly 20 may be reduced.

The plurality of first active material layers 130 may include a negative active material. For example, the plurality of first active material layers 130 may include a material capable of reversibly intercalating/deintercalating lithium ions, a lithium metal, an alloy of a lithium metal, a material capable of being doped with and dedoped from lithium, or a transition metal oxide.

The material capable of reversibly intercalating/deintercalating lithium ions is a carbon-based negative active material, and may include, for example, crystalline carbon, amorphous carbon, or a combination thereof. Examples of the crystalline carbon include graphite such as amorphous, plate-shaped, flake, spherical, or fibrous natural graphite or artificial graphite, and examples of the amorphous carbon include soft carbon or hard carbon, mesophase pitch carbide, calcined coke, etc.

As the alloy of the lithium metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative active material or a Sn-based negative active material may be used. The Si-based negative active material may be silicon, a silicon-carbon composite, SiOₓ (0<x<2), a Si-Q alloy (wherein Q is selected from an alkali metal, an alkaline earth metal, a group 13 element, a group 14 element (excluding Si), a group 15 element, a group 16 element, a transition metal, a rare earth element, and a combination thereof), or a combination thereof. The Sn-based negative active material may be Sn, SnO₂, a Sn-based alloy, or a combination thereof.

The silicon-carbon composite may be a composite of silicon and amorphous carbon. According to embodiments, the silicon-carbon composite may have a form in which silicon particles and amorphous carbon are coated on surfaces of the silicon particles. For example, it may include secondary particles (cores) in which silicon primary particles are assembled and an amorphous carbon coating layer (shell) positioned on surfaces of the secondary particles. The amorphous carbon is also positioned between the silicon primary particles, so that, for example, the silicon primary particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles, and an amorphous carbon coating layer positioned on a surface of the core.

The Si-based negative active material or the Sn-based negative active material may be produced by being mixed with a carbon-based negative active material.

According to some embodiments of the present disclosure, the first electrode plate 100 may further include a first uncoated portion 140 in which the plurality of first active material layers 130 are not applied on the first metal layer 120. For example, a plurality of first uncoated portions 140 may be disposed between respective ones of the plurality of first active material layers 130. The first electrode plate 100 may be folded at the plurality of first uncoated portions 140. For example, the first uncoated portion 140 may be utilized as a portion where the first electrode plate 100 is folded. Because an active material is not applied to the first uncoated portion 140, stress during bending may be minimized. For example, the first uncoated portion 140 disposed between a pair of first active material layers 130 may be folded 90 degrees twice to form a first folded portion 154 and a second folded portion 156.

The first electrode plate 100 may be composed of a plurality of first flat portions 152 and a plurality of folded portions 154 and 156. The plurality of first flat portions 152 may extend along a second direction D2 and may have a generally flat shape. The plurality of first flat portions 152 may include regions where the plurality of first active material layers 130 are applied. The plurality of folded portions 154 and 156 may be positioned corresponding to the first uncoated portions 140 where the plurality of first active material layers 130 are not applied. The plurality of folded portions 154 and 156 may be portions where the first electrode plate 100 is folded. The plurality of folded portions 154 and 156 may extend along a third direction D3 and may have a generally flat shape.

Respective ones of the plurality of first flat portions 152 and the plurality of folded portions 154 and 156 may be positioned alternately one by one. The plurality of folded portions 154 and 156 may be divided into the first folded portion 154 disposed on an outside of the separator 170 and the second folded portion 156 disposed on an inside of the separator 170. Here, an outer side and an inner side of the separator 170 may be defined based on an arrangement structure of the separator 170 and a central portion of the electrode assembly 20. Specifically, the outer side of the separator 170 may mean a region or a direction extending away from the separator 170 toward an outside of the electrode assembly 20. For example, in FIG. 2, both left and right edge regions or directions of the separator 170 may correspond to the outside of the separator 170. On the other hand, the inner side of the separator 170 may mean a region or a direction extending from the separator 170 toward the central portion of the electrode assembly 20. The plurality of folded portions 154 and 156 may extend along the third direction D3 and may have a generally flat shape. For example, they may be arranged/formed in an order of the first flat portion 152, the first folded portion 154, the first flat portion 152, and the second folded portion 156. A width of the first folded portion 154 in the third direction D3 may be greater than a width of the second folded portion 156 in the third direction D3. Here, the second direction D2 may be perpendicular to the third direction D3.

The first electrode tab 160 may be disposed on the first metal layer 120. A detailed example in which the first electrode tab 160, the first insulating layer 165, and the third insulating layer 365 are disposed is further described herein. The first electrode tab 160 may serve as an electrical path for transferring a current generated in the electrode assembly 20 to the outside. The first electrode tab 160 may be formed to protrude in a first direction D1. The first electrode tab 160 may include copper (Cu) or nickel (Ni). However, the present disclosure is not limited thereto.

The first insulating layer 165 may be disposed on the first electrode tab 160. The first insulating layer 165 may prevent damage to the first electrode tab 160 during a manufacturing process of the electrode assembly 20. The first insulating layer 165 may cover not only the first electrode tab 160 but also a region where the first electrode tab 160 is disposed and a part of a peripheral region thereof together. The first insulating layer 165 may have a rectangular shape. However, the present disclosure is not limited thereto.

The first insulating layer 165 may be composed of polyimide (PI), polyethylene (PE), polypropylene (PP), or other materials having insulating properties and flame retardancy. However, the present disclosure is not limited thereto. In an example, the first insulating layer 165 may be implemented as an insulating tape.

The second electrode plate 200 may include a second polymer substrate 210, a second metal layer 220 disposed on one surface of the second polymer substrate 210, and a plurality of second active material layers 230 disposed on the second metal layer 220. The second electrode plate 200 may serve as a current collector of the positive electrode. In this case, the second metal layer 220 may include aluminum (Al). However, the present disclosure is not limited thereto. A metal layer may not be disposed on the other surface of the second polymer substrate 210. Hereinafter, a case where the second electrode plate 200 is a positive electrode plate will be described as a reference.

For example, the second polymer substrate 210 may be formed of an insulating material or a polymer such as PET, PP, PE, PS, PI, and PU. However, the present disclosure is not limited thereto.

The plurality of second active material layers 230 may be disposed to be spaced apart along a surface of the second metal layer 220. The plurality of second active material layers 230 may be disposed on a second flat portion 252 of the second electrode plate 200. The plurality of second active material layers 230 may be electrically connected to each other through the second metal layer 220.

The plurality of second active material layers 230 may include a positive active material. As the positive active material, a compound capable of reversible intercalation and deintercalation of lithium (lithiated intercalation compound) may be used. Specifically, one or more of composite oxides of a metal selected from cobalt, manganese, nickel, or a combination thereof and lithium may be used.

The composite oxide may be a lithium transition metal composite oxide, and specific examples thereof include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following chemical formulas may be used. LiₐA_{1-b}X_{b}O₂-_{c}D_{c} (0.90≤a≤1.8, 0≤b≤0.5, 0≤c≤0.05); LiₐMn₂-_{b}X_{b}O₄-_{c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b>0.5, 0≤c≤0.5, (<α<2); LiₐNi_{b}Co_{c}L1_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐM_{n1-g}G_{g}PO₄ (0.90≤a≤1.8, 0≤g<0.5); Li_{(3-f)}Fe₂(PO₄)₃ (0≤f≤2); LiₐFePO₄ (0.90≤a≤1.8).

In the herein chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

As an example, the positive active material may be a high-nickel-based positive active material in which a content of nickel with respect to 100 mol % of metals excluding lithium in the lithium transition metal composite oxide is greater than or equal to 80 mol %, greater than or equal to 85 mol %, greater than or equal to 90 mol %, greater than or equal to 91 mol %, or greater than or equal to 94 mol % and less than or equal to 99 mol %. The high-nickel-based positive active material can implement a high capacity and thus can be applied to a high-capacity, high-density lithium secondary battery.

According to some embodiments of the present disclosure, the second electrode plate 200 may further include a second uncoated portion 240 in which the plurality of second active material layers 230 are not applied on the second metal layer 220. For example, a plurality of second uncoated portions 240 may be disposed between respective ones of the plurality of second active material layers 230. The second electrode plate 200 may be folded at the plurality of second uncoated portions 240. For example, the second uncoated portion 240 may be utilized as a portion where the second electrode plate 200 is folded. Because an active material is not applied to the second uncoated portion 240, stress during bending may be minimized. For example, the second uncoated portion 240 disposed between a pair of second active material layers 230 may be folded 90 degrees twice to form a third folded portion 254 and a fourth folded portion 256.

The second electrode plate 200 may be composed of a plurality of second flat portions 252 and a plurality of folded portions 254 and 256. The plurality of second flat portions 252 may extend along the second direction D2 and may have a generally flat shape. The plurality of second flat portions 252 may include regions where the plurality of second active material layers 230 are applied. The plurality of folded portions 254 and 256 may be positioned corresponding to the second uncoated portions 240 where the plurality of second active material layers 230 are not applied. The plurality of folded portions 254 and 256 may be portions where the second electrode plate 200 is folded.

The plurality of folded portions 254 and 256 may extend along the third direction D3 and may have a generally flat shape.

The plurality of second flat portions 252 and the plurality of folded portions 254 and 256 may be positioned alternately one by one. The plurality of folded portions 254 and 256 may be divided into the third folded portion 254 disposed on an outside of the separator 170 and the fourth folded portion 256 disposed on an inside of the separator 170. In the second electrode plate 200, the plurality of folded portions 254 and 256 may extend along the third direction D3 and may have a generally flat shape. For example, the plurality of folded portions 254 may be arranged/formed in an order of the second flat portion 252, the third folded portion 254, the second flat portion 252, and the fourth folded portion 256. A width of the third folded portion 254 in the third direction D3 may be greater than a width of the fourth folded portion 256 in the third direction D3.

The second electrode tab 260 may be disposed on the second metal layer 220. The second electrode tab 260 may serve as an electrical path for transferring a current generated in the electrode assembly 20 to the outside of the electrode assembly 20. The second electrode tab 260 may be formed to protrude in the first direction D1. The second electrode tab 260 may include copper (Cu) or nickel (Ni). However, the present disclosure is not limited thereto.

The second insulating layer 265 may be disposed on the second electrode tab 260. The second insulating layer 265 may prevent damage to the second electrode tab 260 during a manufacturing process of the electrode assembly 20. The second insulating layer 265 may cover not only the second electrode tab 260 but also a region where the second electrode tab 260 is disposed and a part of a peripheral region thereof together.

A description of a shape and a material of the second insulating layer 265 may be the same as the description of the shape and the material of the first insulating layer 165. However, the present disclosure is not limited thereto. For example, the second insulating layer 265 may have a shape different from that of the first insulating layer 165, and the second insulating layer 265 may include a material different from that of the first insulating layer 165.

The separator 170 may be interposed/disposed between the first electrode plate 100 and the second electrode plate 200. The separator 170 may serve to prevent an electrical short circuit by blocking physical contact between the first electrode plate 100 and the second electrode plate 200 and to selectively pass only ions. The separator 170 may include a polymer material such as polyethylene (PE) or polypropylene (PP). However, the present disclosure is not limited thereto.

The first electrode plate 100, the separator 170, and the second electrode plate 200 may be folded in a zigzag shape and stacked together to form the electrode assembly 20. For example, the separator 170 may be folded together at locations corresponding to the folded portions 154 and 156 of the first electrode plate 100 and the folded portions 254 and 256 of the second electrode plate 200.

According to some embodiments, at least a portion of the first metal layer 120 may face the separator 170, and at least a portion of the second metal layer 220 may face the separator 170. Accordingly, a structure in which the first metal layer 120 and the second metal layer 220 face each other with the separator 170 therebetween may be formed.

According to some embodiments, a length of the first electrode plate 100 may be greater than a length of the second electrode plate 200. However, the present disclosure is not limited thereto. For example, the length of the second electrode plate 200 may be greater than the length of the first electrode plate 100.

According to some embodiments, the first polymer substrate 110 and the second polymer substrate 210 may form an outermost part of the electrode assembly 20. In this case, because the outermost part of the electrode assembly 20 is protected by a polymer substrate having insulating properties and durability, external impact resistance of the electrode assembly 20 may be improved. In addition, because the outermost part of the electrode assembly 20 can be insulated and protected without a separate insulating layer or an additional finishing process, a manufacturing process may be simplified and a manufacturing cost may be reduced.

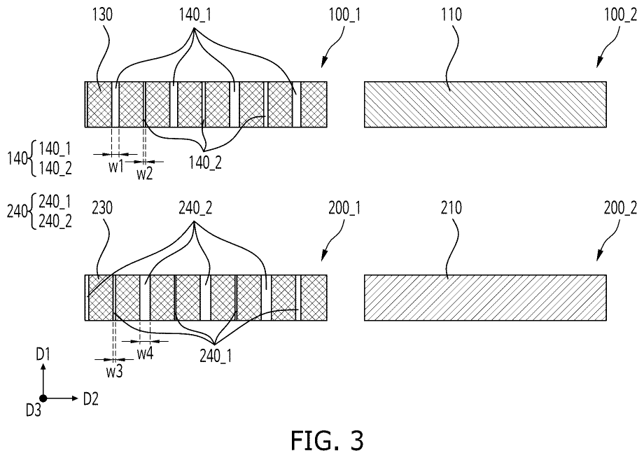

FIG. 3 illustrates a state before bending a first electrode plate and a second electrode plate according to some embodiments of the present disclosure.

Referring to FIG. 3, a first electrode plate and a second electrode plate according to some embodiments may have a first surface and a second surface, respectively. Here, the first surfaces 100_1 and 200_1 may be surfaces facing a separator, and the second surfaces 100_2 and 200_2 may be surfaces disposed at an outermost part of an electrode assembly (or surfaces not facing the separator).

The first surface 100_1 of the first electrode plate may be a surface on which a first metal layer and a first active material layer 130 are disposed on one surface of a first polymer substrate 110. The second surface 100_2 of the first electrode plate may be a second surface (e.g., the other surface) of the first polymer substrate 110.

A plurality of first active material layers 130 may be disposed to be spaced apart from each other in a second direction D2, and accordingly, a plurality of first uncoated portions 140 may be formed. The plurality of first uncoated portions 140 may include a plurality of (1-1)-th uncoated portions 140-1 and a plurality of (1-2)-th uncoated portions 140-2. The plurality of (1-1)-th uncoated portions 140-1 and the plurality of (1-2)-th uncoated portions 140-2 may be alternately disposed such that one first active material layer 130 is interposed between each pair of an adjacent (1-1)-th uncoated portion 140-1 and (1-2)-th uncoated portion 140-2.

The plurality of (1-1)-th uncoated portions 140-1 may correspond to a first folded portion (e.g., the first folded portion 154 in FIG. 2) where the first electrode plate is folded. The plurality of (1-2)-th uncoated portions 140-2 may correspond to a second folded portion (e.g., the second folded portion 156 in FIG. 2) where the first electrode plate is folded. A width w1 of the plurality of (1-1)-th uncoated portions 140-1 in the second direction D2 may be greater than a width w2 of the plurality of (1-2)-th uncoated portions 140-2 in the second direction D2. Here, the width w1 of the plurality of (1-1)-th uncoated portions 140-1 in the second direction D2 and the width w2 of the plurality of (1-2)-th uncoated portions 140-2 in the second direction D2 may be lengths in an extending direction of the first polymer substrate 110 (i.e., a direction in which the first polymer substrate 110 extends).

The first surface 200_1 of the second electrode plate may be a surface on which a second metal layer and a second active material layer 230 are disposed on one surface of a second polymer substrate 210. The second surface 200_2 of the second electrode plate may be a second surface (e.g., the other surface) of the second polymer substrate 210.

A plurality of second active material layers 230 may be disposed to be spaced apart from each other in the second direction D2, and accordingly, a plurality of second uncoated portions 240 may be formed. The plurality of second uncoated portions 240 may include a plurality of (2-1)-th uncoated portions 240-1 and a plurality of (2-2)-th uncoated portions 240-2.

The plurality of (2-1)-th uncoated portions 240-1 and the plurality of (2-2)-th uncoated portions 240-2 may be alternately disposed such that one second active material layer 230 is interposed between each pair of an adjacent (2-1)-th uncoated portion 240-1 and (2-2)-th uncoated portion.

The plurality of (2-1)-th uncoated portions 240-1 may correspond to a third folded (or bending) portion (e.g., the third folded portion 254 in FIG. 2) where the second electrode plate 200 is folded (or bent). The plurality of (2-2)-th uncoated portions 240-2 may correspond to a fourth folded portion (e.g., the fourth folded portion 256 in FIG. 2) where the second electrode plate 200 is folded. A width w3 of the plurality of (2-1)-th uncoated portions 240-1 in the second direction D2 may be less than a width w4 of the plurality of (2-2)-th uncoated portions 240-2 in the second direction D2.

In embodiments, the plurality of (1-1)-th uncoated portions 140-1 of the first electrode plate and the plurality of (2-1)-th uncoated portions 240-1 of the second electrode plate may be disposed at positions corresponding to each other. Also, the plurality of (1-2)-th uncoated portions 140-2 of the first electrode plate and the plurality of (2-2)-th uncoated portions 240-2 of the second electrode plate may be disposed at positions corresponding to each other.

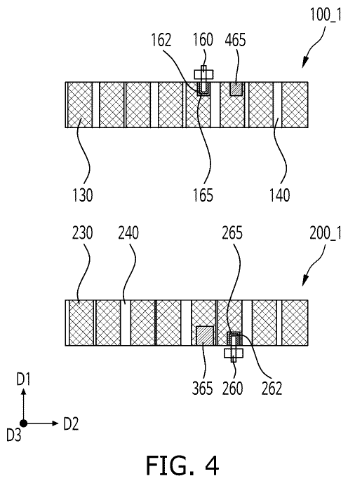

FIG. 4 illustrates a welding structure of an electrode tab according to some embodiments of the present disclosure.

Referring to FIG. 4, a first trench 162 exposing a first metal layer may be formed in one of a plurality of first active material layers 130 disposed on a first surface 100_1 of a first electrode plate. In some embodiments, the first trench 162 may be formed by partially removing the first active material layer 130. However, the present disclosure is not limited thereto. For example, the first trench 162 may be formed by not applying a corresponding active material portion in a process of applying the first active material layer 130.

A first electrode tab 160 may be disposed in the first trench 162 to be electrically connected to a first metal layer 120. For example, the first electrode tab 160 may be fixed on the first metal layer 120 through a method such as ultrasonic welding, laser welding, etc. The first electrode tab 160 may protrude to an outside of the first trench 162 to serve as an electrical path for inducing a current generated in an electrode assembly to the outside.

A first insulating layer 165 may be disposed on the first trench 162, at least a portion of the first electrode tab 160, and at least a portion of one of the plurality of first active material layers 130 surrounding the first trench 162. The first insulating layer 165 may prevent inflow and flow of foreign substances that may occur during a welding process of the first electrode tab 160 or after the welding process, and may prevent unintentional electrical contact and a short circuit between the first electrode tab 160 and an external member. Accordingly, reliability of the electrode assembly may be improved through use of the configuration described herein.

A second trench 262 exposing a second metal layer may be formed in one of a plurality of second active material layers 230 disposed on a first surface 200_1 of a second electrode plate. In some embodiments, the second trench 262 may be formed by partially removing the second active material layer 230. However, the present disclosure is not limited thereto. For example, the second trench 262 may be formed by not applying a corresponding portion in a process of applying the second active material layer 230.

A second electrode tab 260 may be disposed in the second trench 262 to be electrically connected to a second metal layer 220. For example, the second electrode tab 260 may be fixed on the second metal layer 220 through a method such as ultrasonic welding, laser welding, etc. The second electrode tab 260 may protrude to an outside of the second trench 262 to serve as an electrical path for inducing a current generated in the electrode assembly to the outside.

A second insulating layer 265 may be disposed on the second trench 262, at least a portion of the second electrode tab 260, and at least a portion of one of the plurality of second active material layers 230 surrounding the second trench 262. The second insulating layer 265 may prevent inflow and flow of foreign substances that may occur during a welding process of the second electrode tab 260 or after the welding process, and may prevent unintentional electrical contact and a short circuit between the second electrode tab 260 and an external member.

A third insulating layer 365 may be disposed in a partial region of the second electrode plate 200 corresponding to (or facing) a region where the first electrode tab 160 is disposed. Specifically, the third insulating layer 365 may be disposed on the second active material layer 230. A width of the third insulating layer 365 in a first direction D1 and a second direction D2 may be greater than a width of the first insulating layer 165 in the first direction D1 and the second direction D2. Unlike what is illustrated, according to some embodiments, the third insulating layer 365 may be omitted.

A fourth insulating layer 465 may be disposed in a partial region of the first electrode plate corresponding to (or facing) a region where the second electrode tab 260 is disposed. Specifically, the fourth insulating layer 465 may be disposed on the first active material layer 130. A width of the fourth insulating layer 465 in the first direction D1 and the second direction D2 may be greater than a width of the second electrode tab 260 in the first direction D1 and the second direction D2. The width of the fourth insulating layer 465 in the first direction D1 and the second direction D2 may be less than a width of the second insulating layer 265 in the first direction D1 and the second direction D2. Unlike what is illustrated, according to some embodiments, the fourth insulating layer 465 may be omitted.

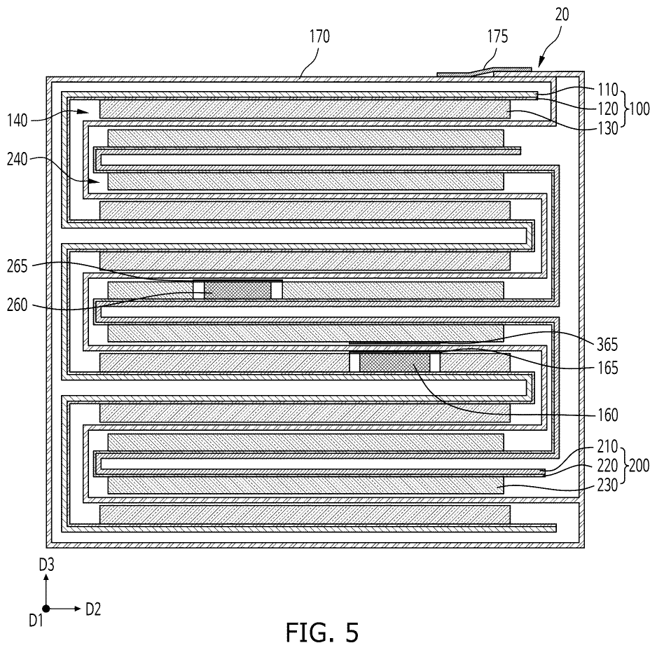

FIG. 5 illustrates a structure in which a separator finishes an outermost part of an electrode assembly according to some embodiments of the present disclosure.

Referring to FIG. 5, a separator 170 according to some embodiments may surround an outermost part of an electrode assembly 20. In this case, compared to a structure in which a first polymer substrate 110 and a second polymer substrate 210 form the outermost part of the electrode assembly 20 (e.g., the structure of FIG. 2), a first active material layer 130 and a second active material layer 230 can be more stably protected. Accordingly, the lifespan and reliability of the electrode assembly 20 can be improved.

A separator securing member 175 may be disposed at an end of the separator 170. The separator securing member 175 fixes the end of the separator 170, thereby preventing infiltration of foreign substances from an outside of the electrode assembly 20, so that reliability and a lifespan of a secondary battery can be improved. The separator securing member 175 may fix the end of the separator 170 by a compression or adhesion method. For example, the separator securing member 175 may be made of a tape, an adhesive, an insulating polymer film, etc. However, the present disclosure is not limited thereto.

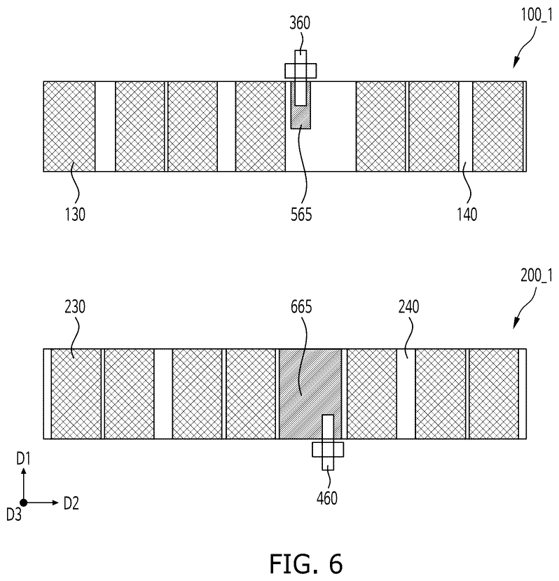

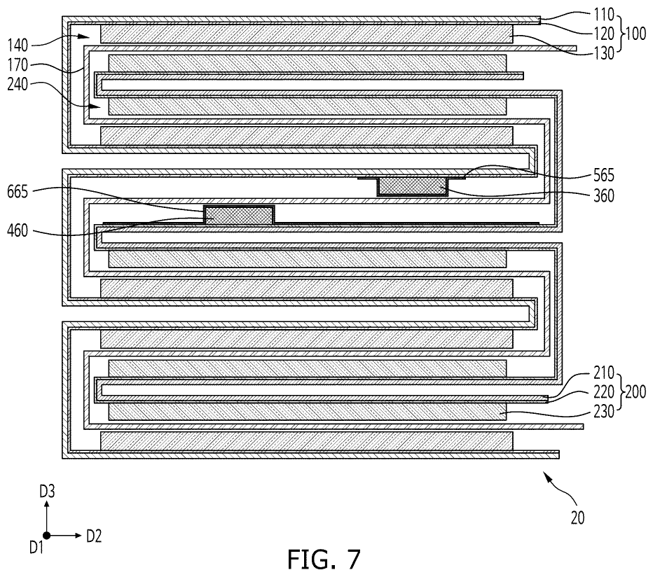

FIGS. 6 to 7 illustrate a welding structure of an electrode tab according to some embodiments of the present disclosure.

Referring to FIGS. 6 to 7, a first surface 100_1 of a first electrode plate may be a surface on which a first metal layer and a first active material layer 130 are disposed on one surface of a first polymer substrate 110. A third electrode tab 360 may be disposed on one of a plurality of first uncoated portions 140. Here, the first uncoated portion on which the third electrode tab 360 is disposed may be a region formed by not disposing a first active material layer in a region where the first active material layer is to be disposed. The third electrode tab 360 may be electrically connected to a first metal layer 120. For example, the third electrode tab 360 may be fixed on the first metal layer 120 through a method such as ultrasonic welding, laser welding, etc. The third electrode tab 360 may serve as an electrical path for transferring a current generated in an electrode assembly 20 to the outside. The third electrode tab 360 may be formed to protrude in a first direction D1.

A fifth insulating layer 565 may be disposed on the third electrode tab 360 and at least a portion of one first uncoated portion on which the third electrode tab 360 is disposed among the plurality of first uncoated portions 140. The fifth insulating layer 565 may prevent damage to the third electrode tab 360 during a manufacturing process of the electrode assembly 20. The fifth insulating layer 565 may cover not only the third electrode tab 360 but also the first uncoated portion 140 where the third electrode tab 360 is disposed and a part of a peripheral region thereof together. The fifth insulating layer 565 may have a rectangular shape. However, the present disclosure is not limited thereto. For example, the fifth insulating layer 565 may be formed in a square, circular, oval, polygonal, or any irregular shape, for example.

A first surface 200_1 of a second electrode plate may be a surface on which a second metal layer and a second active material layer 230 are disposed on one surface of a second polymer substrate 210. A fourth electrode tab 460 may be disposed on one of a plurality of second uncoated portions 240. Here, the second uncoated portion on which the fourth electrode tab 460 is disposed may be a region formed by not disposing a second active material layer in a region where the second active material layer is to be disposed. The fourth electrode tab 460 may be electrically connected to a second metal layer 220. For example, the fourth electrode tab 460 may be fixed on the second metal layer 220 through a method such as ultrasonic welding, laser welding, etc. The fourth electrode tab 460 may serve as an electrical path for transferring a current generated in the electrode assembly 20 to the outside of the electrode assembly 20. The fourth electrode tab 460 may be formed to protrude in the first direction D1.

A sixth insulating layer 665 may be disposed on the fourth electrode tab 460 and at least a portion of one second uncoated portion on which the fourth electrode tab 460 is disposed among the plurality of second uncoated portions 240. The sixth insulating layer 665 may prevent damage to the fourth electrode tab 460 during a manufacturing process of the electrode assembly 20. The sixth insulating layer 665 may cover not only the fourth electrode tab 460 but also the second uncoated portion 240 where the fourth electrode tab 460 is disposed and a part of a peripheral region thereof together. The sixth insulating layer 665 may have a rectangular shape. However, the present disclosure is not limited thereto. For example, the sixth insulating layer 665 may be formed in a square, circular, oval, polygonal, or any irregular shape.

A width of the sixth insulating layer 665 in the first direction D1 and a second direction D2 may be greater than a width of the fifth insulating layer 565 in the first direction D1 and the second direction D2. A description of materials of the fifth insulating layer 565 and the sixth insulating layer 665 may be the same as the description of the first insulating layer 165. However, the present disclosure is not limited thereto.

The second active material layer 230 may not be disposed in a partial region of the second electrode plate corresponding to (or facing) a region where the third electrode tab 360 is disposed, and the sixth insulating layer 665 may be disposed. The first active material layer 130 may not be disposed in a partial region of the first electrode plate corresponding to (or facing) a region where the fourth electrode tab 460 is disposed. An active material layer may not be disposed in regions of the first electrode plate and the second electrode plate corresponding to (or facing) a region where the sixth insulating layer 665 is disposed. Unlike what is illustrated, the fifth insulating layer 565 may be disposed in a partial region of the first electrode plate corresponding to (or facing) a region where the fourth electrode tab 460 is disposed.

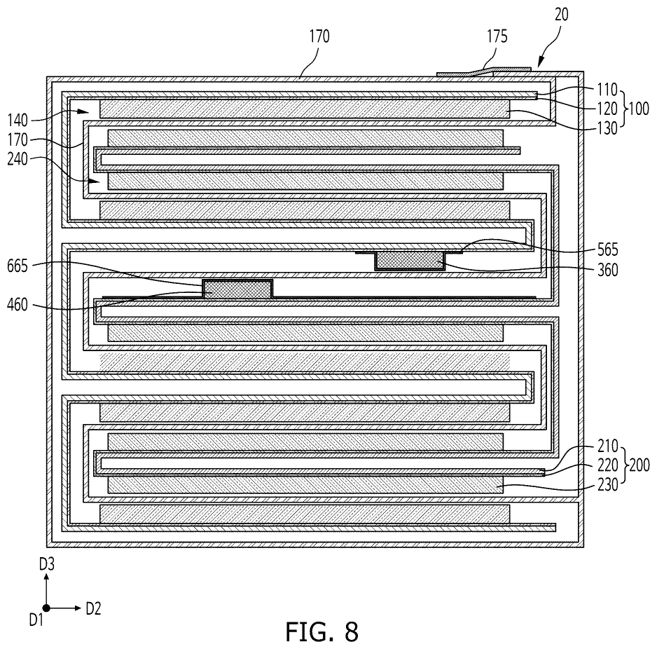

FIG. 8 illustrates a structure in which a separator finishes an outermost part of an electrode assembly according to some embodiments of the present disclosure.

Referring to FIG. 8, a separator 170 may surround an outermost part of an electrode assembly 20 having a structure as shown in FIG. 7. In this case, compared to a structure in which a first polymer substrate 110 and a second polymer substrate 210 form the outermost part of the electrode assembly 20, a first active material layer 130 and a second active material layer 230 can be more stably protected. Accordingly, the lifespan and reliability of the electrode assembly 20 can be improved using the configuration described herein.

A separator securing member 175 may be disposed at an end of the separator 170. The separator securing member 175 fixes the end of the separator 170, thereby preventing infiltration of foreign substances from an outside of the electrode assembly 20, so that reliability and a lifespan of a secondary battery can be improved. The separator securing member 175 may fix the end of the separator 170 by a compression or adhesion method. For example, the separator securing member 175 may be made of a tape, an adhesive, an insulating polymer film, etc. However, the present disclosure is not limited thereto.

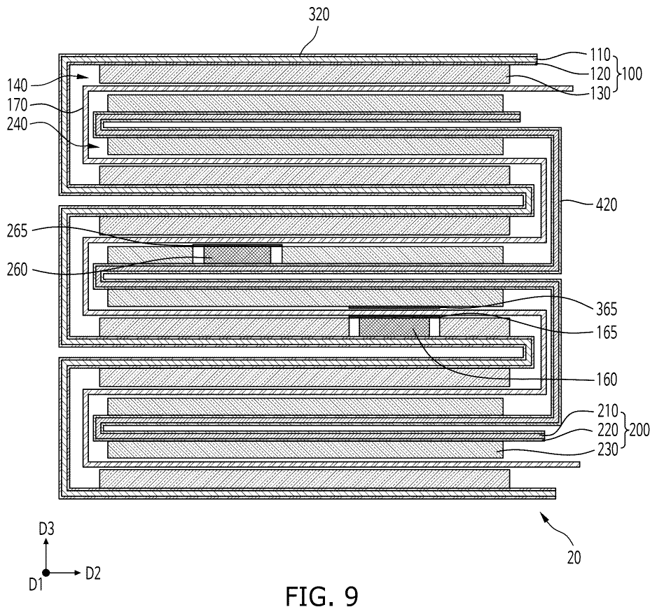

FIG. 9 is a diagram illustrating a structure of an electrode assembly according to some embodiments of the present disclosure.

Referring to FIG. 9, a first metal layer 120 may be disposed on one surface of a first polymer substrate 110, and a third metal layer 320 may be disposed on the other surface of the first polymer substrate 110 on which the first metal layer 120 is not disposed. The third metal layer 320 may be disposed on a surface opposite to the first metal layer 120. The third metal layer 320 and the first metal layer 120 may be electrically insulated from each other with the first polymer substrate 110 therebetween. The third metal layer 320 may be made of the same material as the first metal layer 120. However, the present disclosure is not limited thereto. For example, the third metal layer 320 may be made of a material different from that of the first metal layer 120.

A second metal layer 220 may be disposed on one surface of a second polymer substrate 210, and a fourth metal layer 420 may be disposed on the other surface of the second polymer substrate 210 on which the second metal layer 220 is not disposed. The fourth metal layer 420 may be disposed on a surface opposite to the second metal layer 220. The fourth metal layer 420 and the second metal layer 220 may be electrically insulated from each other with the second polymer substrate 210 therebetween. The fourth metal layer 420 may be made of the same material as the second metal layer 220. However, the present disclosure is not limited thereto. For example, the fourth metal layer 420 may be made of a material different from that of the second metal layer 220.

According to the herein-described configuration, because it has the same layer arrangement as a metal-insulating layer-metal structure widely used in a conventional composite substrate electrode plate, existing manufacturing facilities and electrode plate processes can be utilized. Accordingly, compatibility of manufacturing facilities is secured, and introduction of new equipment can be minimized.

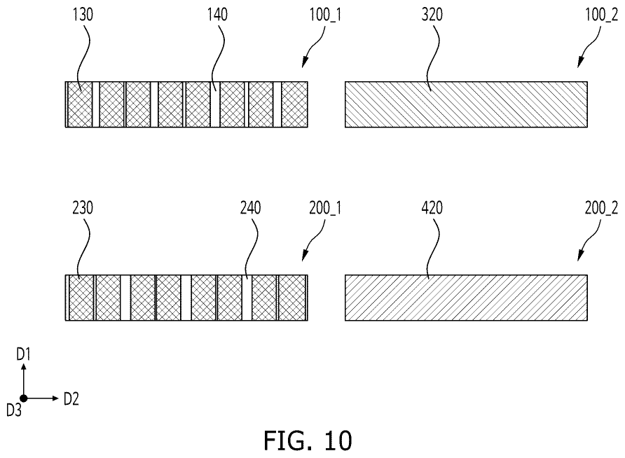

FIG. 10 illustrates a state before bending a first electrode plate and a second electrode plate according to some embodiments of the present disclosure.

Referring to FIG. 10, a first electrode plate and a second electrode plate according to some embodiments may have a first surface 100_1 and 200_1 and a second surface 100_2 and 200_2, respectively. Here, the first surfaces 100_1 and 200_1 may be surfaces facing a separator, and the second surfaces 100_2 and 200_2 may be surfaces disposed at an outermost part of an electrode assembly (or surfaces not facing the separator).

The first surface 100_1 of the first electrode plate may be a surface on which a first metal layer and a first active material layer 130 are disposed on one surface of a first polymer substrate 110. The second surface 100_2 of the first electrode plate may be the other surface of the first electrode plate on which a third metal layer 320 is disposed. In some embodiments, an active material layer may not be disposed on the third metal layer 320.

The first surface 200_1 of the second electrode plate may be a surface on which a second metal layer and a second active material layer 230 are disposed on one surface of a second polymer substrate 210. The second surface 200_2 of the second electrode plate may be the other surface of the second electrode plate on which a fourth metal layer 420 is disposed. In some embodiments, an active material layer may not be disposed on the fourth metal layer 420.

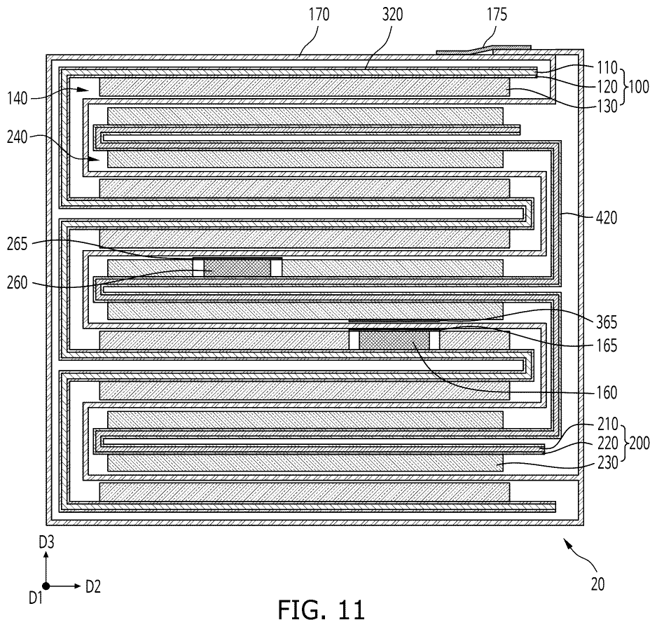

FIG. 11 illustrates a structure in which a separator finishes an outermost part of an electrode assembly according to some embodiments of the present disclosure.

Referring to FIG. 11, a separator 170 may surround an outermost part of an electrode assembly 20 having a structure as shown in FIG. 9. Unlike the structure of the electrode assembly 20 illustrated in FIG. 2, in the first electrode plate 100 and the second electrode plate 200 of FIG. 11, both surfaces are formed of metal layers 320 and 420, so that safety of the electrode assembly 20 can be effectively improved through a configuration in which the separator 170 surrounds the outermost part of the electrode assembly 20. Because a separator securing member 175 has been described herein, a detailed description thereof will be omitted.

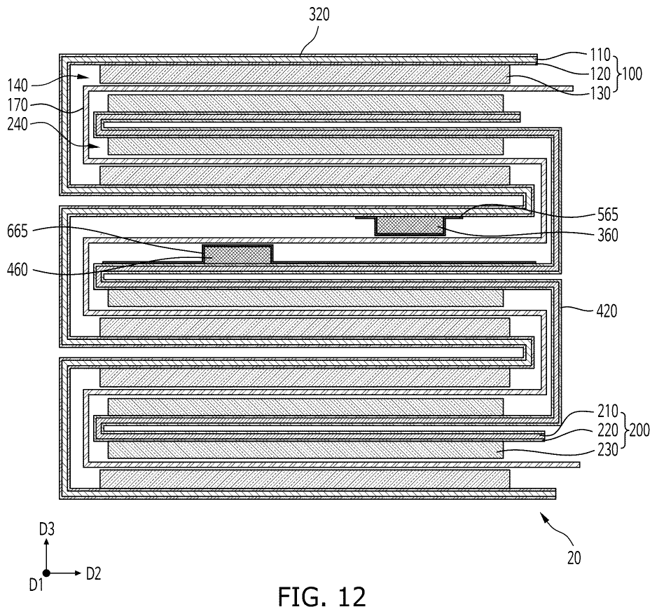

FIG. 12 is a diagram illustrating a structure of an electrode assembly according to some embodiments of the present disclosure.

Referring to FIG. 12, unlike the structure of the electrode assembly 20 shown in FIG. 7, a third metal layer 320 may be disposed on the other surface on which a first metal layer 120 is not disposed on a first polymer substrate 110. The third metal layer 320 and the first metal layer 120 may be electrically insulated from each other with the first polymer substrate 110 therebetween.

A second active material layer 230 may not be disposed in a partial region of a second electrode plate 200 corresponding to (or facing) a region where a third electrode tab 360 is disposed, and a sixth insulating layer 665 may be disposed. A first active material layer 130 may not be disposed in a partial region of a first electrode plate 100 corresponding to (or facing) a region where a fourth electrode tab 460 is disposed.

Unlike what is illustrated, a fifth insulating layer 565 may be disposed in a partial region of the first electrode plate 100 corresponding to (or facing) a region where the fourth electrode tab 460 is disposed.

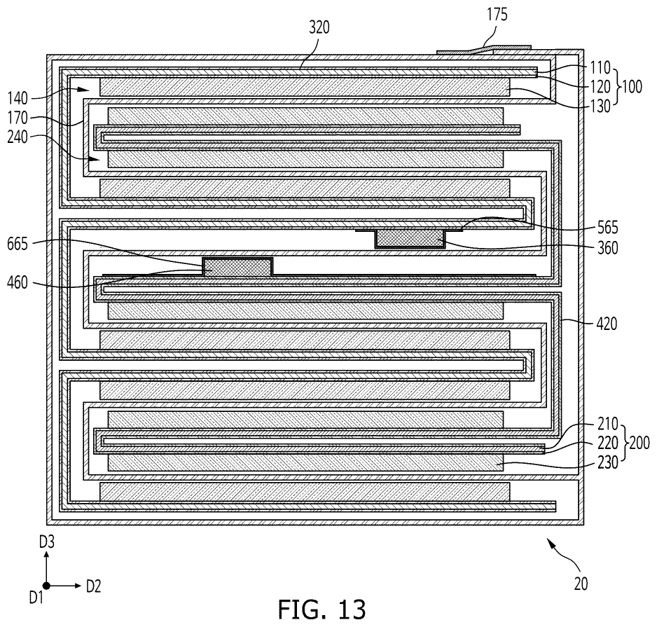

FIG. 13 illustrates a structure in which a separator finishes an outermost part of an electrode assembly according to some embodiments of the present disclosure.

Referring to FIG. 13, a separator 170 may surround an outermost part of an electrode assembly 20 having a structure as shown in FIG. 12. Unlike the structure of the electrode assembly 20 illustrated in FIG. 8, in the first electrode plate 100 and the second electrode plate 200 of FIG. 13, both surfaces are formed of metal layers 320 and 420, so that safety of the electrode assembly 20 can be effectively improved through a configuration in which the separator 170 surrounds the outermost part of the electrode assembly 20. Because a separator securing member 175 has been described herein, a detailed description thereof will be omitted.

Although the present disclosure has been described herein with respect to certain embodiments thereof, the present disclosure is not limited thereto. Various modifications and variations can be made thereto by those skilled in the art within the spirit of the present disclosure and the equivalent scope of the appended claims.

What is claimed is:

1. An electrode assembly comprising:
a first electrode plate comprising a first polymer substrate, a first metal layer on one surface of the first polymer substrate, and a plurality of first active material layers on the first metal layer;
a second electrode plate comprising a second polymer substrate, a second metal layer on one surface of the second polymer substrate, and a plurality of second active material layers on the second metal layer; and
a separator interposed between the first electrode plate and the second electrode plate,
wherein the first electrode plate, the separator, and the second electrode plate are folded in a zigzag shape and stacked together.

2. The electrode assembly as claimed in claim 1, wherein the plurality of first active material layers are electrically connected to each other through the first metal layer, and
the plurality of second active material layers are electrically connected to each other through the second metal layer.

3. The electrode assembly as claimed in claim 1, wherein a length of the first electrode plate is greater than a length of the second electrode plate.

4. The electrode assembly as claimed in claim 1, further comprising:
a plurality of first uncoated portions disposed between respective ones of the plurality of first active material layers; and
a plurality of second uncoated portions disposed between respective ones of the plurality of second active material layers.

5. The electrode assembly as claimed in claim 4, wherein: the first electrode plate is folded at the plurality of first uncoated portions,
the second electrode plate is folded at the plurality of second uncoated portions,
at least a portion of the first metal layer faces the separator, and
at least a portion of the second metal layer faces the separator.

6. The electrode assembly as claimed in claim 4, wherein the plurality of first uncoated portions comprise a plurality of (1-1)-th uncoated portions and a plurality of (1-2)-th uncoated portions,
respective ones of the plurality of (1-1)-th uncoated portions and the plurality of (1-2) -th uncoated portions are alternately disposed such that one first active material layer is interposed between each pair of an adjacent (1-1)-th uncoated portion of the plurality of (1-1)-th uncoated portions and an (1-2)-th uncoated portion of the plurality of (1-2)-th uncoated portions,
a width of the plurality of (1-1)-th uncoated portions is greater than a width of the plurality of (1-2)-th uncoated portions,
the plurality of second uncoated portions comprise a plurality of (2-1)-th uncoated portions and a plurality of (2-2)-th uncoated portions,
respective ones of the plurality of (2-1)-th uncoated portions and the plurality of (2-2)-th uncoated portions are alternately disposed such that one second active material layer is interposed between each pair of an adjacent (2-1)-th uncoated portion of the plurality of (2-1)-th uncoated portions and a (2-2)-th uncoated portion of the plurality of (2-2)-th uncoated portions, and
a width of the plurality of (2-1)-th uncoated portions is less than a width of the plurality of (2-2)-th uncoated portions.

7. The electrode assembly as claimed in claim 1, comprising:
a first trench formed in one of the plurality of first active material layers to expose the first metal layer;
a first electrode tab disposed in the first trench;
a second trench formed in one of the plurality of second active material layers to expose the second metal layer; and
a second electrode tab disposed in the second trench.

8. The electrode assembly as claimed in claim 7, further comprising:
a first insulating layer on the first trench, at least a portion of the first electrode tab, and at least a portion of one of the plurality of first active material layers surrounding the first trench; and
a second insulating layer on the second trench, at least a portion of the second electrode tab, and at least a portion of one of the plurality of second active material layers surrounding the second trench.

9. The electrode assembly as claimed in claim 4, further comprising:
a first electrode tab on one of the plurality of first uncoated portions; and
a second electrode tab on one of the plurality of second uncoated portions.

10. The electrode assembly as claimed in claim 9, further comprising:
a first insulating layer on at least a portion of one of the plurality of first uncoated portions and at least a portion of the first electrode tab; and
a second insulating layer on at least a portion of one of the plurality of second uncoated portions and at least a portion of the second electrode tab.

11. The electrode assembly as claimed in claim 1, wherein the first electrode plate further comprises a first folded portion disposed on an outside of the separator and a second folded portion disposed on an inside of the separator, and
a width of the first folded portion is greater than a width of the second folded portion.

12. The electrode assembly as claimed in claim 1, wherein the separator further comprises a separator securing member surrounding an outermost part of the electrode assembly and disposed at an end of the separator.

13. The electrode assembly as claimed in claim 1, wherein the first polymer substrate and the second polymer substrate form an outermost part of the electrode assembly.

14. The electrode assembly as claimed in claim 1, further comprising:
a third metal layer on another surface of the first polymer substrate opposite the first metal layer; and
a fourth metal layer on another surface of the second polymer substrate opposite to the second metal layer.

15. The electrode assembly as claimed in claim 14, further comprising:
a first trench formed in one of the plurality of first active material layers to expose the first metal layer;
a first electrode tab disposed in the first trench;
a second trench formed in one of the plurality of second active material layers to expose the second metal layer;
a second electrode tab disposed in the second trench;
a first insulating layer disposed on the first trench, at least a portion of the first electrode tab, and at least a portion of one of the plurality of first active material layers surrounding the first trench; and
a second insulating layer disposed on the second trench, at least a portion of the second electrode tab, and at least a portion of one of the plurality of second active material layers surrounding the second trench.

16. The electrode assembly as claimed in claim 14, further comprising:
a plurality of first uncoated portions disposed between respective ones of the plurality of first active material layers;
a plurality of second uncoated portions disposed between respective ones of the plurality of second active material layers;
a first electrode tab on one of the plurality of first uncoated portions;
a second electrode tab on one of the plurality of second uncoated portions;
a first insulating layer on at least a portion of one of the plurality of first uncoated portions and at least a portion of the first electrode tab; and
a second insulating layer on at least a portion of one of the plurality of second uncoated portions and at least a portion of the second electrode tab.

17. The electrode assembly as claimed in claim 14, wherein the separator further comprises a separator securing member surrounding an outermost part of the electrode assembly and disposed at an end of the separator.

18. A secondary battery comprising:
an electrode assembly comprising a first electrode plate including a first polymer substrate, a first metal layer on one surface of the first polymer substrate, and a plurality of first active material layers on the first metal layer, a second electrode plate including a second polymer substrate, a second metal layer on one surface of the second polymer substrate, and a plurality of second active material layers on the second metal layer, and a separator interposed between the first electrode plate and the second electrode plate;
a first electrode tab on the first metal layer;
a second electrode tab on the second metal layer; and
a case configured to accommodate the electrode assembly,
wherein the first electrode plate, the separator, and the second electrode plate are folded in a zigzag shape and stacked together.

19. The secondary battery as claimed in claim 18, wherein:
the plurality of first active material layers are electrically connected to each other through the first metal layer, and
the plurality of second active material layers are electrically connected to each other through the second metal layer.

20. The secondary battery as claimed in claim 18, wherein the first polymer substrate and the second polymer substrate form an outermost part of the electrode assembly.
